(19) United States
(12) Patent Application Publication
(10) Pub. No.: US 2015/0034742 A1
(43) Pub. Date: Feb. 5, 2015

(54) FUEL INJECTOR AND FUEL INJECTION DEVICE USING THE SAME

(71) Applicant: DENSO CORPORATION, Kariya-city (JP)

(72) Inventors: Keigo OOHATA, Kariya-city (JP); Nobuo OOTA, Takahama-city (JP)

(73) Assignee: DENSO CORPORATION, Kariya-city (JP)

(21) Appl. No.: 14/331,605

(22) Filed: Jul. 15, 2014

(30) Foreign Application Priority Data
Jul. 30, 2013 (JP) 2013-158283

(51) Int. Cl. F02M 69/04; F02M 51/06

(52) U.S. Cl. CPC F02M 69/042; F02M 51/061
USPC 239/584

(57) ABSTRACT

A fuel injector includes (i) a body including a distal end portion forming an injection port, a diameter reduction portion, and a diameter expansion portion, and (ii) a seal member attached to at least the diameter reduction portion of both the diameter reduction portion and the diameter expansion portion. When the body is inserted into an attachment hole communicating with a combustion chamber of an internal combustion engine, the seal member seals between an inner peripheral surface of the attachment hole and an outer peripheral surface of the body. The seal member includes a first taper portion chamfered and provided at an outer periphery of a distal end portion of the seal member in a case where the distal end portion of the seal member is placed at a position relatively close to the injection port.

### CROSS REFERENCE TO RELATED APPLICATION

This application is based on Japanese Patent Application No. 2013-158283 filed on Jul. 30, 2013, the disclosure of which is incorporated herein by reference.

### TECHNICAL FIELD

The present disclosure relates to a fuel injector injecting fuel to an internal combustion engine.

### BACKGROUND

Conventionally, a fuel injector disclosed in JP-2002-364494A is well known. According to JP-2002-364494A, in the fuel injector, a seal member which is cylindrical-shaped is attached to an attachment groove formed in a nozzle portion corresponding to a distal end portion of the fuel injector. The attachment groove includes a diameter reduction portion that a diameter of which is reduced, and a taper surface expanding a diameter of the attachment groove from the diameter reduction portion toward a base end portion of the nozzle portion. A step surface is provided between a base end portion of the taper surface and an outer peripheral portion of the nozzle portion.

The seal member is generally attached to an area of the diameter reduction portion at an initial stage. The fuel injector provided with the seal member is inserted into an attachment hole provided in a cylinder head. The seal member seals between an inner peripheral surface of the attachment hole and an outer peripheral surface of the nozzle portion, and a leakage of a combustion gas is prevented.

Even though a creep deformation is generated in the seal member with time, since the seal member is moved by a pressure of the combustion gas toward the base end portion of the nozzle portion to cover the taper surface, the outer peripheral surface of the seal member is in contact with the inner peripheral surface at a surface pressure that is sufficient. Therefore, a seal efficiency is ensured for a long period of time. The seal efficiency can be ensured during an ensuring period until a distal end portion of the seal member reaches the step surface.

However, in a case where the fuel injector provided with the seal member is inserted into the attachment hole, when the seal member is still inserted into the attachment hole even the seal member is engaged with an inlet portion of the attachment hole, the seal member may be damaged, or the seal member is moved to cover a part of the taper surface at the initial stage.

When the seal member is damaged, the seal efficiency cannot be ensured. When the seal member is moved to cover a part of the taper surface, a distance from the distal end portion of the seal member to the step surface becomes shorter because the seal member is moved toward a distal end portion of the nozzle portion according to the pressure of the combustion gas, and a covering amount that is allowed for the seal member moving toward the taper surface becomes shorter. Therefore, the ensuring period becomes shorter.

### SUMMARY

It is an object of the present disclosure to provide a fuel injector which improves an insertion ability of when the fuel injector is inserted into an attachment hole, and restricts a damage of a seal member or a generation of the seal member moving toward a base end portion.

According to an aspect of the present disclosure, a fuel injector includes a body and a seal member. The body includes a distal end portion forming an injection port through which fuel is injected. The body further includes a diameter reduction portion and a diameter expansion portion expanding a diameter of the diameter expansion portion from the diameter reduction portion toward a base end portion of the diameter expansion portion opposite to the injection port. The seal member is substantially cylindrical-shaped and attached to at least an outer peripheral surface of the diameter reduction portion. When the body is inserted into an attachment hole communicating with a combustion chamber of an internal combustion engine, the seal member seals between an inner peripheral surface of the attachment hole and an outer peripheral surface of the body. The seal member includes a first taper portion chamfered and provided at an outer periphery of a distal end portion of the seal member in a case where the distal end portion of the seal member is placed at a position relatively close to the injection port.

When the fuel injector is inserted into the attachment hole, the insertion ability can be improved according to the first taper portion. Therefore, an improper engagement between the attachment hole and the seal member is restricted, and the damage of the seal member or a generation of the seal member moving toward the diameter expansion portion can be restricted.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a sectional view showing a fuel injector attached to an attachment hole, according to an embodiment of the present disclosure;

FIG. 2 is an enlarged view showing a seal member provided at an initial stage;

FIG. 3 is an enlarged view showing the seal member after the fuel injector is attached to the attachment hole; and

FIG. 4 is a diagram showing a list of determining results at various conditions.

### DETAILED DESCRIPTION

Embodiments of the present disclosure will be described hereafter referring to drawings. In the embodiments, a part that corresponds to a matter described in a preceding embodiment may be assigned with the same reference numeral, and redundant explanation for the part may be omitted. When only a part of a configuration is described in an embodiment, another preceding embodiment may be applied to the other parts of the configuration. The parts may be combined even if it is not explicitly described that the parts can be combined. The embodiments may be partially combined even if it is not explicitly described that the embodiments can be combined, provided there is no harm in the combination.

Hereafter, referring to drawings, embodiments of the present disclosure will be described. The substantially same parts or components as those in the embodiments are indicated with the same reference numerals and the same descriptions may be omitted. When a part of an embodiment is detailed, regarding to other parts of the embodiment, the descriptions of previous embodiments can be applied to the embodiment. Further, it is to be understood that the disclosure is not limited to the embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

### Embodiment

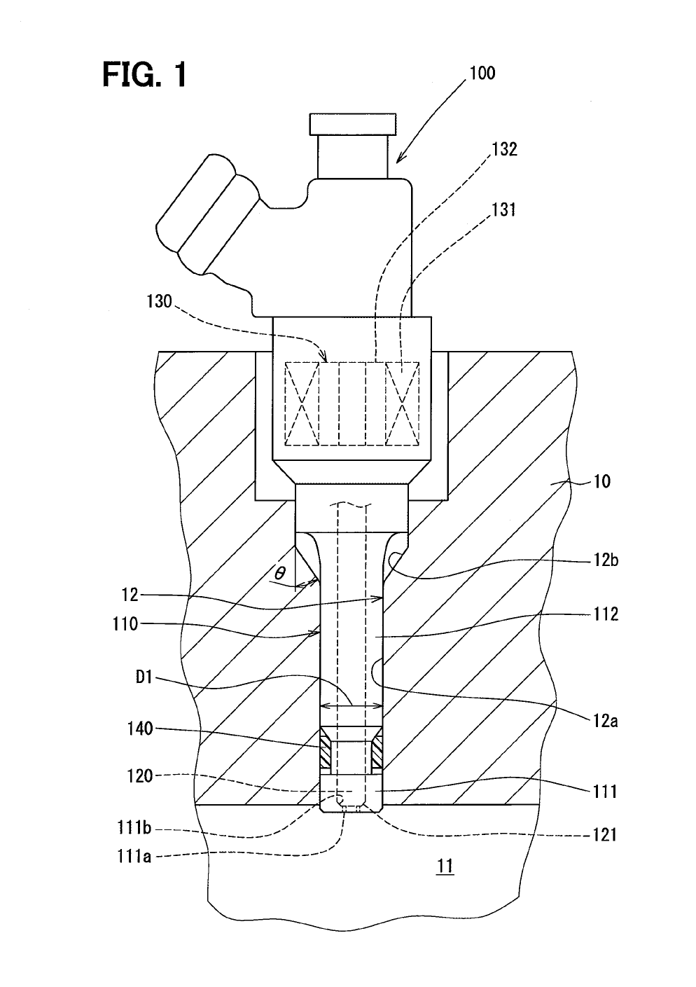

Referring to FIGS. 1 to 3, a fuel injector 100 according to an embodiment will be described. The fuel injector 100 is mounted to an internal combustion engine of an ignition type. According to the present embodiment, the internal combustion engine corresponds to a gasoline engine. The fuel injector 100 directly injects fuel to a combustion chamber 11 provided in a cylinder head 10 of the internal combustion engine. The cylinder head 10 forms an attachment hole 12 communicating with the combustion chamber 11 and an exterior of the cylinder head 10. The fuel injector 100 includes a body 110 inserted into the attachment hole 12.

An inner surface of the attachment hole 12 corresponds to an inner peripheral surface 12a. A hole taper portion 12b is chamfered and provided around an end portion of the attachment hole 12 into which the body 110 is inserted. According to the present embodiment, for example, an angle of chamfering the hole taper portion 12b corresponding to a hole chamfering angle θ is 5 degrees. An inner diameter of the attachment hole 12 is referred to as an inner diameter D1.

The fuel injector 100 includes the body 110, a valve member 120, a driving portion 130, and a seal member 140.

The body 110 is an elongated part provided at a distal end portion of the fuel injector 100, and includes a fuel passage therein. The body 110 further includes an injection-port portion 111 provided at a distal end portion of the body 110, and a base portion 112 provided at a base end portion of the body 110.

The injection-port portion 111 includes an injection port 111a provided at a distal end portion of the injection-port portion 111, a valve seat surface 111b provided inside of the injection-port portion 111. The fuel is injected via the injection port 111a. A distal end portion of the valve member 120 is seated on the valve seat surface 111b. An outer diameter of the injection-port portion 111 is referred to as an outer diameter D11. The outer diameter D11 is set to be slightly less than the inner diameter D1 of the attachment hole 12.

The base portion 112 includes a diameter reduction portion 112a which is provided at a distal end portion of the base portion 112 and is adjacent to the injection-port portion 111, and a diameter expansion portion 112b provided at a position between the diameter reduction portion 112a and a base end portion of the base portion 112. The diameter reduction portion 112a has a first predetermined dimension in an axial direction of the diameter reduction portion 112a. An outer diameter D13 of the diameter reduction portion 112a is reduced with respect to an outer diameter D12 of the base portion 112. The outer diameter D12 of the base portion 112 is set to be substantially equal to the outer diameter D11 of the injection-port portion 111. The first predetermined dimension of the diameter reduction portion 112a is set to be equal to an axial-direction dimension of the seal member 140 corresponding to a dimension of the seal member 140 in an axial direction of the seal member 140. An outer periphery of the diameter reduction portion 112a corresponds to a reduction outer peripheral surface 112c. According to the present embodiment, the reduction outer peripheral surface 112c also corresponds to an outer peripheral surface of the body 110.

The diameter expansion portion 112b has a second predetermined dimension in an axial direction of the diameter expansion portion 112b. The diameter expansion portion 112b smoothly expands a diameter of the diameter expansion portion 112b from the diameter reduction portion 112a toward a base end portion of the diameter expansion portion 112b opposite to the injection port 111a. A part of the diameter expansion portion 112b which expands most has an outer diameter D14 that is slightly less than the outer diameter D12 of the base portion 112. Therefore, relationships between the above outer diameters are (i) the outer diameter D12 is substantially equal to the outer diameter D11, (ii) the outer diameter D12 is greater than the outer diameter D14, and (iii) the outer diameter D14 is greater than the outer diameter D13. The second predetermined dimension of the diameter expansion portion 112b is set to be a value capable of establishing a covering amount (CA) of the seal member 140 and a gap amount (GA) of the diameter expansion portion 112b. An outer periphery of the diameter expansion portion 112b corresponds to an expansion outer peripheral surface 112d.

The valve member 120 is a needle-shaped valve provided in the fuel passage of the body 110. The valve member 120 includes a sealing surface 121 provided at a distal end portion of the valve member 120 and seated on the valve seat surface 111b. A movable core which is not shown is fixed to a base end portion of the valve member 120.

The driving portion 130 driving the valve member 120 is provided in an area placed at a base end portion of the fuel injector 100 outside a base end portion of the body 110. The driving portion 130 includes an electromagnetic coil 131, a stator core 132, and a spring that is not shown. The spring biases the valve member to close the valve member 120 via the movable core.

When the electromagnetic coil 131 is energized, the stator core 132 generates a magnetic attraction force. The magnetic attraction force cancels a biasing force of the spring and makes the movable core of the valve member 120 moves toward the stator core 132. Therefore, both the valve member 120 and the movable core are lifted up, that is, both the valve member 120 and the movable core operate in a valve-opening operation. In this case, the fuel is injected from the injection port 111a.

When the electromagnetic coil 131 is deenergized, the magnetic attraction force disappears. Both the valve member 120 and the movable core operate in a valve-closing operation, according to the biasing force of the spring. In this case, a fuel injection from the injection port 111a is stopped.

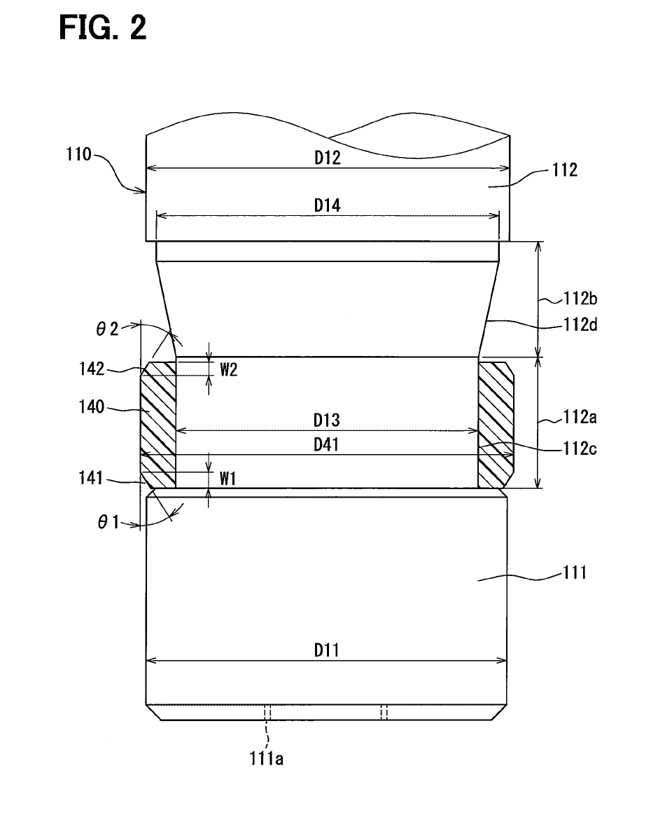

As shown in FIG. 2, the seal member 140 corresponds to a seal portion attached to the diameter reduction portion 112a before the fuel injector 100 is inserted into the attachment hole 12. When the body 110 is inserted into the attachment hole 12 such that the fuel injector 100 is assembled, the seal member 140 seals a space between the inner peripheral surface 12a and the outer peripheral surface of the body 110. In this case, the outer peripheral surface of the body 110 corresponds to the reduction outer peripheral surface 112c. In other words, the seal member 140 is attached to the reduction outer peripheral surface 112c. A combustion gas in the combustion chamber 11 is prevented from leaking via the space, by the seal member 140. Since the seal member 140 is deformable when being assembled and is necessary to have a heat resisting property, the seal member 140 is made of fluororesin or elastomer. For example, the seal member 140 may be made of Teflon (registered trademark).

The seal member 140 is substantially cylindrical-shaped. An outer diameter D41 of the seal member 140 is set to be slightly greater than the inner diameter D1 of the attachment hole 12. The axial-direction dimension of the seal member 140 is set to be substantially equal to the first predetermined dimension of the diameter reduction portion 112a. The seal member 140 is attached to the diameter reduction portion 112a at an initial stage.

The seal member 140 includes a first taper portion 141 chamfered and provided at an outer periphery of a distal end portion of the seal member 140. The distal end portion of the seal member 140 is placed at a position relatively close to the injection port 111a. An angle of chamfering the first taper portion 141 is referred to as a first chamfering angle θ1, and a width of chamfering the first taper portion 141 is referred to as a first chamfering width W1. The first chamfering angle θ1 of the first taper portion 141 is set to be equal to the hole chamfering angle θ of the hole taper portion 12b.

The seal member 140 further includes a second taper portion 142 chamfered and provided at an outer periphery of a base end portion of the seal member 140. The base end portion of the seal member 140 is placed at a position relatively farther from the injection port 111a than the distal end portion of the seal member 140. The second taper portion 142 is formed to have the same shape as the first taper portion 141. An angle of chamfering the second taper portion 142 corresponding to a second chamfering angle θ2, and a width of chamfering the second taper portion 142 corresponding to a second chamfering width W2, are set to be equal to the first chamfering angle θ1 and the first chamfering width W1, respectively.

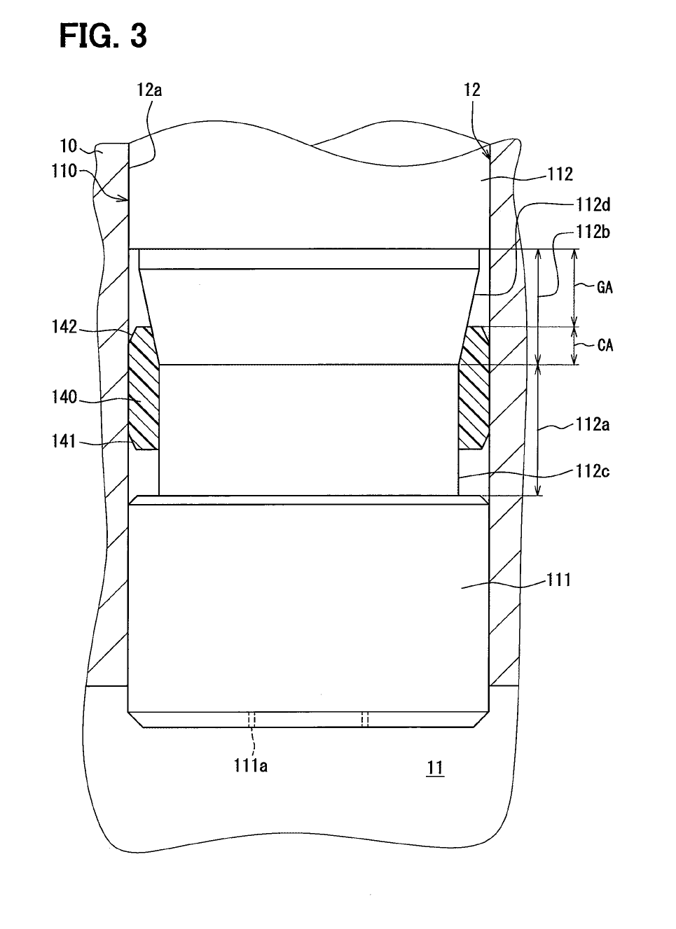

When the body 110 is inserted into the attachment hole 12 such that the fuel injector 100 is attached to the cylinder head 10, the first taper portion 141 contacts the hole taper portion 12b, further, is inserted into the attachment hole 12. As shown in FIG. 3, the seal member 140 is moved with respect to the body 110 according to a friction between the inner peripheral surface 12a and the outer peripheral surface of the seal member 140. That is, a part of the base end portion of the seal member 140 is moved toward the body 110 to cover a part of the diameter expansion portion 112b.

When the fuel injector 100 is used in a vehicle, the seal member 140 is further moved toward the base end portion of the body 110 according to a pressure of the combustion gas in the combustion chamber 11 with time, thereby increasing the covering amount of the seal member 140. Since a space between the inner peripheral surface 12a and the expansion outer peripheral surface 112d decreases in a direction toward the base end portion of the body 110, a recovery force applied to the seal member 140 increases in accordance with an increase in covering amount, and a seal efficiency can be held for a long term. Further, the covering amount of the seal member 140 corresponds to a dimension of the seal member 140 that covers the diameter expansion portion 112b in the axial direction of the diameter expansion portion 112b.

The seal member 140 is attached to the diameter reduction portion 112a at the initial stage. As the above description, it is likely that the seal member 140 is moved toward the diameter expansion portion 112b to span across the diameter reduction portion 112a and the diameter expansion portion 112b.

The gap amount is obtained by subtracting the covering amount from an axial-direction dimension of the diameter expansion portion 112b. The axial-direction dimension of the diameter expansion portion 112b corresponds to a dimension of the diameter expansion portion 112b in the axial direction of the diameter expansion portion 112b. The gap amount indicates a capability of the seal member 140 moving toward the diameter expansion portion 112b.

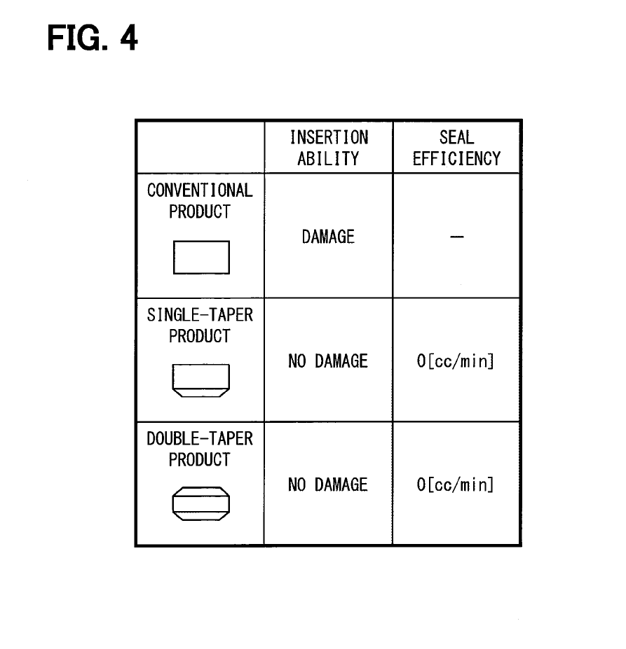

A bench test is executed for the vehicle, so as to confirm an insertion ability relative to the attachment hole 12, a damage of the seal member 140, and the seal efficiency, in the fuel injector 100 according to the present embodiment. Test conditions and test points are indicated as followings. FIG. 4 is a diagram showing test results of the bench test.

### <Test Conditions and Test Points>

### 1. Samples of the Seal Member

1) Conventional product (provided without a taper portion, and the axial-direction dimension is equal to 3.15 mm)

2) Single-taper product (provided with the first taper portion 141, the first chamfering angle θ1 is equal to 5 degrees, and the first chamfering width W1 is equal to 0.8 mm)

3) Double-taper product (provided with the first taper portion 141 and the second taper portion 142, the first chamfering angle θ1 and the second chamfering angle θ2 are equal to 5 degrees, and the first chamfering width W1 and the second chamfering width W2 are equal to 0.8 mm)

### 2. Estimation of the Insertion Ability

1) An radial-direction dimension of the seal member: Set to maximum (inner diameter and thickness are set to the maximum values of design stage)

2) Surface roughness of the attachment hole: Ten-point mean roughness (Rz) is 6.3 (a maximum level of the vehicle)

3) Method of inserting: the seal member is pressed by an Amsler testing machine into the hole taper portion 12b after the seal member is in contact with the hole taper portion 12b.

### 3. Estimation of the Seal Efficiency at a Low Temperature

1) The radial-direction dimension of the seal member: Set to minimum (inner diameter and thickness are set to the minimum values of design stage)

2) Pre-compression operation: Execute a compression load for 100 times at 60 degrees Celsius, 4 MPa

3) Then, a leakage amount is detected from the seal portion at minus 40 degrees Celsius, 3 MPa.

### <Test Results>

### 1. Estimation of the Insertion Ability

As shown in FIG. 4, in the conventional product provided without a taper portion, the damage of the seal member 140 is generated by an improper engagement of the seal member relative to the attachment hole 12.

However, both the single-taper product and the double-taper product are provided with the first taper portion 141 such that an insertion load is sharply reduced. Therefore, the damage of the seal member is not generated, and a good result is obtained.

### 2. Estimation of the Seal Efficiency at a Low Temperature

As shown in FIG. 4, both the leakage amount of the single-taper product and the leakage amount of the double-taper product are 0 cc/min. Therefore, regarding the seal efficiency, a good result is obtained.

As the above description, according to the present embodiment, the first taper portion 141 is provided at the outer periphery of the distal end portion of the seal member 140 in a case where the distal end portion of the seal member 140 is placed at a position relatively close to the injection port 111a. Therefore, when the fuel injector 100 is inserted into the attachment hole 12, the insertion load is reduced by the first taper portion 141, and the insertion ability can be improved. Then, the improper engagement between the attachment hole 12 and the seal member 140 is restricted, and the damage of the seal member 140 or a generation of the seal member 140 moving toward the diameter expansion portion 112b can be restricted.

The first chamfering angle θ1 of the first taper portion 141 is set to be equal to the hole chamfering angle θ of the hole taper portion 12b. Therefore, an entire periphery of the hole taper portion 12b can be in contact with an entire periphery of the first taper portion 141. Then, a slope of an axial center of the body 110 is restricted, and the body 110 can be inserted into the attachment hole 12. Further, the damage of the seal member 140 or the generation of the seal member 140 moving toward the diameter expansion portion 112b can be restricted.

The second taper portion 142 which has the same shape as the first taper portion 141 is provided at the outer periphery of the base end portion of the seal member 140 in a case where the base end portion of the seal member 140 is placed at a position relatively farther from the injection port 111a than the distal end portion of the seal member 140. Therefore, the seal member 140 can be attached to the diameter reduction portion 112a without considering a directionality for attaching the seal member 140, and an attachment operation becomes simple.

### Other Embodiment

According to the above embodiment, the seal member 140 includes the first taper portion 141 and the second taper portion 142. However, the seal member 140 may only include the first taper portion 141. In this case, even though the directionality for attaching the seal member 140 to the diameter reduction portion 112a occurs, the insertion ability relative to the attachment hole 12 can obtain the same effects as the above embodiment.

According to the above embodiment, the first chamfering angle θ1 of the first taper portion 141 is set to be equal to the hole chamfering angle A of the hole taper portion 12b. However, the first chamfering angle θ1 may be set to a value different from the hole chamfering angle θ, in a case where the first taper portion 141 and the hole taper portion 12b are properly in contact with each other.

According to the above embodiment, as shown in FIG. 1, the fuel injector 100 is provided in the cylinder head 10. However, the fuel injector may be provided in a cylinder block. According to the above embodiment, the fuel injector 100 is mounted to the internal combustion engine of an ignition type such as a gasoline engine. However, the fuel injector may be mounted to an internal combustion engine of a compression self-ignition type such as a diesel engine. According to the above embodiment, the fuel injector directly injects fuel to the combustion chamber 11. However, the fuel injector may inject fuel to an intake pipe.

While the present disclosure has been described with reference to the embodiments thereof, it is to be understood that the disclosure is not limited to the embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

What is claimed is:

1. A fuel injector comprising:
a body including a distal end portion forming an injection port through which fuel is injected, the body further including a diameter reduction portion and a diameter expansion portion expanding a diameter of the diameter expansion portion from the diameter reduction portion toward a base end portion of the diameter expansion portion opposite to the injection port; and
a seal member substantially cylindrical-shaped and attached to at least an outer peripheral surface of the diameter reduction portion, wherein
when the body is inserted into an attachment hole communicating with a combustion chamber of an internal combustion engine, the seal member seals between an inner peripheral surface of the attachment hole and an outer peripheral surface of the body, and
the seal member includes a first taper portion chamfered and provided at an outer periphery of a distal end portion of the seal member in a case where the distal end portion of the seal member is placed at a position relatively close to the injection port.

2. The fuel injector according to claim 1, wherein
the seal member further includes a second taper portion which has the same shape as the first taper portion and is provided at an outer periphery of a base end portion of the seal member in a case where the base end portion of the seal member is placed at a position relatively farther from the injection port than the distal end portion of the seal member.

3. The fuel injector according to claim 1, further comprising:
a hole taper portion chamfered and provided around an end portion of the attachment hole into which the body is inserted, wherein
a chamfering angle of the first taper portion is set to be equal to a chamfering angle of the hole taper portion.
